(19) United States
(12) Patent Application Publication
(10) Pub. No.: US 2024/0256323 A1
(43) Pub. Date: Aug. 1, 2024

(54) EXTENDED CLOUD BASED SYSTEM AND METHOD FOR TASK ALLOCATION

(71) Applicants: Naveen Kumar SHARMA, Jaipur (IN); Apurv BORDIA, Jaipur (IN)

(72) Inventors: Naveen Kumar SHARMA, Jaipur (IN); Apurv BORDIA, Jaipur (IN); Kiran SHARMA, Jaipur (IN); Nupur BORDIA, Jaipur (IN); Shankar Ganesh Pillaiyar Nattamai Jeyaprakash, Bangalore (IN)

(21) Appl. No.: 18/423,376

(22) Filed: Jan. 26, 2024

(30) Foreign Application Priority Data
Jan. 26, 2023 (IN) 202211042863

(51) Int. Cl. G06F 9/455

(52) U.S. Cl. CPC G06F 9/45558; G06F 2009/45591; G06F 2009/45595

(57) ABSTRACT

Disclosed is a system (100) that includes a plurality of node (106a-106n) configured to monitor a first set of nodes (124a-124e) to determine presence of at least one unhealthy node in the first set of nodes (124a-124e). The plurality of nodes (106a-106n) redirects a plurality of data packets associated with the at least one unhealthy node to a node that is near to the at least one unhealthy node. The plurality of nodes (106a-106n) is further configured to select a second set of nodes (126a-126e) from the first set of nodes (124a-124e) based on one or more constraints associated with one or more services. The second set of nodes (126a-126e) retrieves one or more protocols to execute the one or more constraints.

### TECHNICAL FIELD

The present disclosure generally relates to the field of cloud computing. More particularly, the present disclosure relates to an extended cloud-based system and method for task allocation to a number of data centers in a blockchain network.

### BACKGROUND

Cloud is a vast network of remote servers around the globe, which are interconnected and meant to operate as a single ecosystem. Cloud servers, which are divided geographically, typically use their own dedicated networking infrastructure. Cloud Service Providers (CSPs) cannot sufficiently support their own cloud infrastructure, as they may rely on a third party for the networking services. The reliance on third-party networking services does not guarantee trustworthiness, and thus raises additional security concerns.

Modern cloud computing infrastructures are inadequately prepared to ensure a seamless distributed compute and storage experience. Proprietary algorithms and protocols may exist internally within organizations and differ from one data center to another. ARIN, which is a governance body responsible for assigning IP addresses to internet service providers (ISPs) does not curate a centralized resource where one could feasibly look up different data centers, not including levels of compliance, technical capacities and geographical constraints. Several state of art technologies that manage cloud computers require a human interaction to monitor automations and make intelligent decisions from the data output streams.

Thus, a secure system with automated cloud management and task allocation to data centers is an ongoing effort and demands a need for improvised technical solution that overcomes the aforementioned problems.

### SUMMARY

In view of the foregoing, a system is disclosed. The system includes a plurality of nodes configured to monitor a first set of nodes to determine presence of at least one unhealthy node in the first set of nodes. The plurality of nodes redirects a plurality of data packets associated with the at least one unhealthy node to a node that is near to the at least one unhealthy node. The plurality of nodes further configured to select a second set of nodes from the first set of nodes based on one or more constraints associated with one or more services. The second set of nodes retrieves one or more protocols to execute the one or more constraints.

In some aspects of the present disclosure, the plurality of nodes further configured to authenticate the first set of nodes prior to monitor the first set of nodes.

In some aspects of the present disclosure, the system further includes a server that is communicatively coupled to the plurality of nodes and configured to store the one or more protocols that facilitate to execute the one or more constraints.

In some aspects of the present disclosure, each node of the plurality of nodes includes one or more virtual machines. The one or more virtual machines of the second set of nodes facilitate to retrieve the one or more protocols from the server.

In some aspects of the present disclosure, the one or more virtual machines of the first set of nodes facilitates to redirect the plurality of data packets of the at least one unhealthy node to a node that is near to the at least one unhealthy node.

In some aspects of the present disclosure, the system further includes a user device that is communicatively coupled to the plurality of nodes and configured to receive first and second queries from a user.

In some aspects of the present disclosure, the first query corresponds to the one or more services that are required by the user and the second query corresponds to the one or more constraints that are associated with the one or more services.

In some aspects of the present disclosure, a method for cloud management and task allocation is disclosed. The method further includes authenticating, by way of a plurality of nodes, a first set of nodes of the plurality of nodes. The method further includes monitoring, by way of the plurality of nodes, the first set of nodes to determine presence of at least one unhealthy node in the first set of nodes. The method further includes redirecting, by way of the plurality of nodes, a plurality of data packets associated with the at least one unhealthy node to a node that is near to the at least one unhealthy node. The method further includes selecting, by way of the plurality of nodes, a second set of nodes from the first set of nodes based on one or more constraints associated with one or more services.

In some aspects of the present disclosure, the method further includes, upon selecting the second set of nodes, retrieving, by way of one or more virtual machines of the second set of nodes, the one or more protocols from the server.

In some aspects of the present disclosure, prior to authenticating, the method further includes receiving, by way of a user device, first and second queries from a user such that the first query corresponds to one or more services that are required by the user and the second query corresponds to one or more constraints that are associated with the one or more services.

### BRIEF DESCRIPTION OF DRAWINGS

The above and still further features and advantages of aspects of the present disclosure becomes apparent upon consideration of the following detailed description of aspects thereof, especially when taken in conjunction with the accompanying drawings, and wherein:

FIG. 1 illustrates a block diagram of a WEB based system for cloud management and task allocation to a plurality of nodes in a blockchain network, in accordance with an aspect of the present disclosure;

FIG. 2 illustrates a block diagram of the server of the system, in accordance with an aspect of the present disclosure;

FIG. 3 illustrates a flow diagram of method that facilitates a user to join the system 100, in accordance with an aspect of the present disclosure; and

FIG. 4 illustrates a flow diagram of method for cloud management and task allocation to the nodes in a blockchain network, in accordance with an aspect of the present disclosure.

To facilitate understanding, like reference numerals have been used, where possible, to designate like elements common to the figures.

### DETAILED DESCRIPTION

Various aspects of the present disclosure provide an extended cloud-based system and method for task allocation. The following description provides specific details of certain aspects of the disclosure illustrated in the drawings to provide a thorough understanding of those aspects. It should be recognized, however, that the present disclosure can be reflected in additional aspects and the disclosure may be practiced without some of the details in the following description.

The various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

It is understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

The subject matter of example aspects, as disclosed herein, is described specifically to meet statutory requirements. However, the description itself is not intended to limit the scope of this disclosure. Rather, the inventor/inventors have contemplated that the claimed subject matter might also be embodied in other ways, to include different features or combinations of features similar to the ones described in this document, in conjunction with other technologies. Generally, the various aspects including the example aspects relate to an extended cloud-based system and method for task allocation.

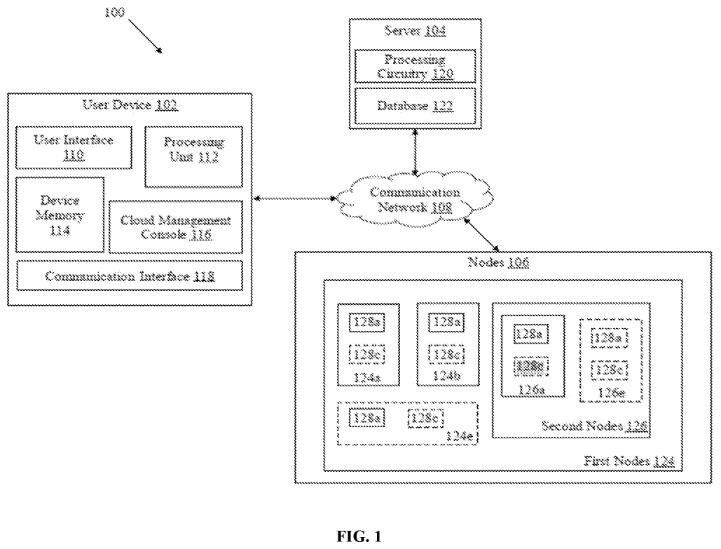

FIG. 1 illustrates a block diagram of a WEB based system 100 for cloud management and task allocation to a plurality of nodes in a blockchain network, in accordance with an aspect of the present disclosure. The system 100 may be configured to detect an unhealthy node in real time and move or shift one or more operations associated with the unhealthy node to a nearest available node with low latency and high response times. The system 100 may therefore ensure maximum uptime. The system 100 may enable open-source indexing of all peer resources and compliances. Additionally, the system 100 may inherit security, data integrity and trust mechanisms from internet of protection (IOP) and global distributed firewall system (GDFS) and may reshape existing public cloud services such as infrastructure as a service (IaaS), platform as a service (PaaS) and software as a service (SaaS). In some aspects of the present disclosure, the system 100 may facilitate the user to solicit a cloud-based service either from a dedicated provider selling several vendors for a commission, or through signing up on the system 100. In some aspects of the present disclosure, the system 100 may authenticate the user and provide grant to the plurality of nodes based on the specifications provided by the user.

The system 100 may include a user device 102, a server 104, and a plurality of nodes 106a-106n (hereinafter collectively referred to and designated as “the nodes 106”). The user device 102, the server 104, and the nodes 106 may be communicatively coupled to each other by way of a communication network 108.

The user device 102 may include a user interface 110, a processing unit 112, a device memory 114, a cloud management console 116, and a communication interface 118.

The user device 102 may be configured to receive instructions and constraints for service from the user. Specifically, the user device 102 may be configured to receive a first query from the user. The first query may correspond to one or more services that may be required by the user. For example, the one or more services may include, but are not limited to, storage-based services, computational resources, network services, management and orchestration services. The storage-based services may facilitate the user to choose to use an external cloud-based hard drive to save space. The computational resources may facilitate the user to choose to utilize powerful nodes to speed up calculations and efficiency without the burden of having to invest in a supercomputer. The network services may facilitate the user to only pay for a dedicated internet protocol (IP address) to host a website and for other purposes. The management and orchestration services may facilitate the user to utilize dedicated software manufactured by the system 100 that may facilitate management of several hundreds of virtual machines at a large scale. The user device 102 may be further configured to receive a second query from the user. The second query may correspond to one or more constraints that may be associated with the one or more services. The one or more constraints may include, but not limited to, (i) organization-specific constraints that may be required to be met and (ii) legal compliances that may be required to be met. Thus, the system 100 may enable the user to fine tune the nodes 106 based on the one or more constraints. Specifically, the system 100 may enable the user to fine tune the nodes 106 based on the organization-specific constraints and legal compliances.

In some aspects of the present disclosure, the user device 102 may be configured to facilitate the user to provide input(s) to register on the system 100. In some other aspects of the present disclosure, the user device 102 may facilitate the user to enable a password protection for logging-in (i.e., user authentication) to the system 100.

The user interface 110 may include an input interface (not shown) for receiving inputs from the user. The input interface may be configured to enable the user to select and/or provide inputs for registration and/or authentication of the user to use one or more functionalities in the system 100. The input interface may be further configured to enable the user to provide inputs to enable password protection for logging-in to the system 100. The user interface 110 may further include an output interface (not shown) for displaying (or presenting) an output to the user. Specifically, the output interface may be configured to display or present the first and second queries. The output interface may be further configured to present or display (i) the one or more services that may be required by the user, (ii) the one or more constraints that may be associated with the one or more services, and (iii) the nodes 106 that may be fine-tuned by the user based on the one or more constraints.

In some aspects of the present disclosure, the input interface may be one of, a touch interface, a mouse, a keyboard, a motion recognition unit, a gesture recognition unit, a voice recognition unit, or the like. Aspects of the present disclosure are intended to include and/or otherwise cover any type of the input interface, without deviating from the scope of the present disclosure.

In some aspects of the present disclosure, the output interface may be one of, a digital display, an analog display, a touch screen display, a graphical user interface, a website, a webpage, a keyboard, a mouse, a light pen, an appearance of a desktop, and/or illuminated characters. Aspects of the present disclosure are intended to include and/or otherwise cover any type of the output interface including known and/or later developed technologies, without deviating from the scope of the present disclosure.

The processing unit 112 may include suitable logic, instructions, circuitry, interfaces, and/or codes for executing various operations, such as the operations associated with the user device 102, and/or the like. In some aspects of the present disclosure, the processing unit 112 may utilize one or more processors such as Arduino or raspberry pi or the like. The processing unit 112 may be further configured to control one or more operations executed by the user device 102 in response to the input received at the user interface 110 from the user. Examples of the processing unit 112 may include, but not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. Aspects of the present disclosure are intended to include or otherwise cover any type of processing unit 112 including known, related art, and/or later developed processing units.

The device memory 114 may be configured to store the logic, instructions, circuitry, interfaces, and/or codes of the processing unit 112, data associated with the user device 102, and/or data associated with the system 100. The device memory 114 may be configured to store a variety of inputs received from the user. Examples of the device memory 114 may include, but not limited to, a Read-Only Memory (ROM), a Random-Access Memory (RAM), a flash memory, a removable storage drive, a hard disk drive (HDD), a solid-state memory, a magnetic storage drive, a Programmable Read Only Memory (PROM), an Erasable PROM (EPROM), and/or an Electrically EPROM (EEPROM). Aspects of the present disclosure are intended to include or otherwise cover any type of device memory 114 including known, related art, and/or later developed memories.

The cloud management console 116 may be configured as a computer-executable application, to be executed by the processing unit 112. The cloud management console 116 may include suitable logic, instructions, and/or codes for executing various operations and may be controlled by the system 100. The one or more computer executable applications may be stored in the device memory 114. Examples of the one or more computer executable applications may include, but are not limited to, an audio application, a video application, a social media application, a navigation application, or the like. Aspects of the present disclosure are intended to include and/or otherwise cover any type of the computer executable application including known, related art, and/or later developed computer executable applications.

The communication interface 118 may be configured to enable the user device 102 to communicate with the server 104 and the nodes 106. Specifically, the communication interface 118 may be configured to enable the user device 102 to communicate with the server 104 and the nodes 106 through the communication network 108. Examples of the communication interface 118 may include, but not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit. It will be apparent to a person of ordinary skill in the art that the communication interface 118 may include any device and/or apparatus capable of providing wireless or wired communications between the user device 102, the server 104, and the nodes 106.

The server 104 may be coupled to the user device 102. Specifically, the server 104 may be communicatively coupled to the user device 102 through the communication network 108. The server 104 may be a network of computers, a software framework, or a combination thereof, that may provide a generalized approach to create a server implementation. Examples of the server 104 may include, but are not limited to, personal computers, laptops, mini-computers, mainframe computers, any non-transient and tangible machine that can execute a machine-readable code, cloud-based servers, distributed server networks, or a network of computer systems. The server 104 may be realized through various web-based technologies such as, but not limited to, a Java web-framework, a .NET framework, a personal home page (PHP) framework, or any web-application framework. The server 104 may be maintained by a storage facility management authority or a third-party entity that facilitates service enablement and resource allocation operations of the system 100. The server 104 may include processing circuitry 120 and one or more memory units 122a-122m (hereinafter, collectively referred to and designated as “the database 122”). The server 104 may be configured to store one or more protocols. The one or more protocols may be configured to facilitate to execute one or more constraints. In other words, the one or more protocols may be a set of instructions that may facilitate to impose or execute the one or more constraints. In some exemplary aspects of the present disclosure, the one or more protocols may be the set of instructions that may facilitate to impose or execute the (i) organization-specific constraints that may be required to be met and (ii) legal compliances that may be required to be met.

The processing circuitry 120 may include suitable logic, instructions, circuitry, interfaces, and/or codes for executing various operations, such as user matching based on interests or the like. The processing circuitry 120 may be configured to host and enable the cloud management console 116 running on (or installed on) the user device 102 to execute the operations associated with the system 100 by communicating one or more commands and/or instructions over the communication network 106. Examples of the processing circuitry 120 may include, but are not limited to, an ASIC processor, a RISC processor, a CISC processor, a FPGA, and the like. The processing circuitry 120 may be configured to perform various operations of the system 100. Specifically, the processing circuitry 120 may be configured to generate a pattern of the nodes 106. In other words, the processing circuitry 120 may be configured to arrange the nodes 106 in the pattern. The processing circuitry 120 may be configured to generate the pattern of the nodes 106 in response to the first and second queries. Specifically, the processing circuitry 120 may be configured to generate the pattern of the nodes 106 based on (i) the one or more services that may be required by the user and (ii) the one or more constraints that may be associated with the one or more services. In some examples, the processing circuitry 120 may be configured to generate the pattern of the nodes 106 based on parameters such as, compliances, geographical location, available resources, capacity, latency, response time, and the like. In some other examples, the processing circuitry 120 may be configured to generate a first pattern of the nodes 106 in response to the storage-based services. In some other examples, the processing circuitry 120 may be configured to generate a second pattern of the nodes 106 in response to the computational resources. In some other examples of the present disclosure, the processing circuitry 120 may be configured to generate a third pattern of the nodes 106 in response to the network services. In some other examples of the present disclosure, the processing circuitry 120 may be configured to generate a fourth pattern of the nodes 106 in response to the management and orchestration services.

The database 122 may be configured to store the logic, instructions, circuitry, interfaces, and/or codes of the processing circuitry 120 for executing various operations. The database 122 may be further configured to store therein data associated with users registered with the system 100. The data associated with the users may include, but is not limited to, username, bank of the user, bank account numbers of each bank, user identifier (ID), credit score, bill summary, history of transactions, and the like. Some aspects of the present disclosure are intended to include and/or otherwise cover any type of the data associated with the users registered with the system 100. Examples of the database 122 may include but are not limited to, a ROM, a RAM, a flash memory, a removable storage drive, a HDD, a solid-state memory, a magnetic storage drive, a PROM, an EPROM, and/or an EEPROM. In some aspects of the present disclosure, a set of centralized or distributed network of peripheral memory devices may be interfaced with the server 104, as an example, on a cloud server. The database 122 may be configured to store the one or more protocols. The one or more protocols may be configured to facilitate to execute the one or more constraints.

The nodes 106 may include a first set of nodes 124a-124e (hereinafter collectively referred to and designated as “the first nodes 124”). The first nodes 124 may include a second set of nodes 126a-126e (hereinafter collectively referred to and designated as “the second nodes 126”). Each node of the nodes 106 may further include one or more virtual machines (VM's) 128a-128c (hereinafter collectively referred to and designated as “the VM's 128”). In other words, the VM's 128 may be installed on each node of the nodes 106. The VM's 128 may be configured to facilitate the user with (not limited to) one or more computational and storage related services. The VM's 128 may interface with the server 104 to derive instructions and operational information required to perform resource-intensive operations. Thus, the VM's 128 may advantageously eliminate gas fees as a by-product.

The nodes 106 may be configured to authenticate the first nodes 124. The nodes 106 may be further configured to monitor the first nodes 124 to determine the presence of at least one unhealthy node in the first nodes 124. The term “unhealthy node” as used herein context of the present disclosure refers to a node that may be affected, operationally down, and may have a latency level that may be higher than a desired value. The nodes 106 may be further configured to redirect a plurality of data packets upon determining presence of the at least one unhealthy node in the first nodes 124. Specifically, the nodes 106 may be configured to redirect the plurality of data packets associated with the at least one unhealthy node to a node of the nodes 106 that may be present near to the at least one unhealthy node. The VM's 128 that may be associated with the first nodes 124 may facilitate redirecting the plurality of data packets of the at least one unhealthy node to the node that may be near to the at least one unhealthy node. The nodes 106 may be further configured to select the second nodes 126 from the first nodes 124 based on one or more constraints. Specifically, the nodes 106 may be configured to select the second nodes 126 from the first nodes 124 based on the one or more constraints that may be associated with one or more services. The second nodes 126 may be configured to retrieve one or more protocols that may facilitate to execute the one or more constraints. Specifically, the VM's 128 of the second nodes 126 may facilitate retrieving the one or more protocols from the server 104.

The communication network 108 may include suitable logic, circuitry, and interfaces that may be configured to provide a number of network ports and a number of communication channels for transmission and reception of data related to operations of various entities (such as the user device 102, the server 104, and the nodes 106) of the system 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 108 may be associated with an application layer for implementation of communication protocols based on one or more communication requests from the user device 102, the server 104, and the nodes 106. The communication data may be transmitted or received via the communication protocols. Examples of the communication protocols may include, but not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In operation, the system 100 may be configured to receive the first and second queries from the user. Specifically, the user device 102 may be configured to receive the first and second queries from the user. The first query may correspond to one or more services that may be required by the user. For example, the one or more services may include, but are not limited to, storage-based services, computational resources, network services, management and orchestration services. The second query may correspond to one or more constraints that may be associated with the one or more services. The one or more constraints may include, but not limited to, (i) organization-specific constraints that may be required to be met and (ii) legal compliances that may be required to be met. The system 100 may be further configured to generate the pattern of the nodes 106 in response to the first and second queries. Specifically, the processing circuitry 120 may be configured to generate the pattern of the nodes 106. The system 100 may be further configured to authenticate the first nodes 124. Specifically, the nodes 106 may be configured to authenticate the first nodes 124. The nodes 106 may be further configured to monitor the first nodes 124 to determine the presence of the at least one unhealthy node in the first nodes 124. The nodes 106 may be further configured to redirect the plurality of data packets upon determining presence of the at least one unhealthy node in the first nodes 124. Specifically, the nodes 106 may be configured to redirect the plurality of data packets associated with the at least one unhealthy node to a node of the nodes 106 that may be present near to the at least one unhealthy node. The VM's 128 that may be associated with the first nodes 124 may facilitate redirecting the plurality of data packets of the at least one unhealthy node to the node that may be near to the at least one unhealthy node. The nodes 106 may be further configured to select the second nodes 126 from the first nodes 124 based on one or more constraints. Specifically, the nodes 106 may be configured to select the second nodes 126 from the first nodes 124 based on the one or more constraints that may be associated with one or more services. The second nodes 126 may be configured to retrieve one or more protocols that may facilitate to execute the one or more constraints. Specifically, the VM's 128 of the second nodes 126 may facilitate retrieving the one or more protocols from the server 104.

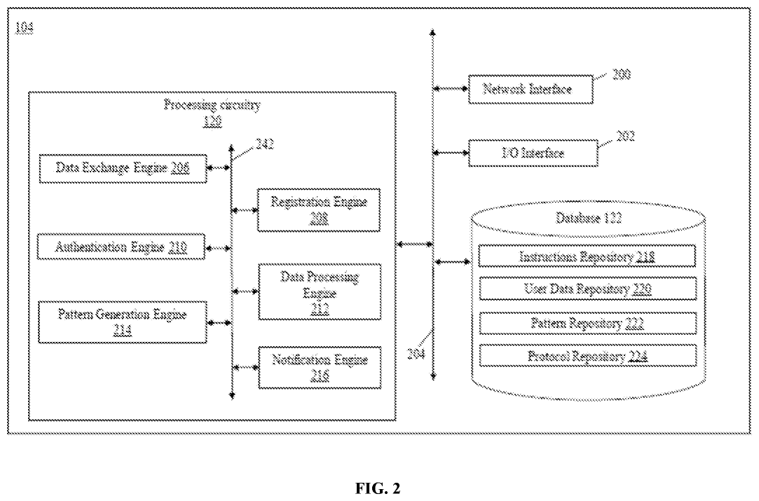

FIG. 2 illustrates a block diagram of the server 104 of the system 100, in accordance with an aspect of the present disclosure. The server 104 may further include a network interface 200 and an input/output (I/O) interface 202. The processing circuitry 120, the database 122, the network interface 200, and the I/O interface 202 may be configured to communicate with each other by way of a first communication bus 204.

The processing circuitry 120 may include a data exchange engine 206, a registration engine 208, an authentication engine 210, a data processing engine 212, a pattern generation engine 214, and a notification engine 216. The data exchange engine 206, the registration engine 208, the authentication engine 210, the data processing engine 212, the pattern generation engine 214, and the notification engine 216 may be configured to communicate with each other by way of a second communication bus 218. It will be apparent to a person skilled in the art that the server 104 is for illustrative purposes and not limited to any specific combination of hardware circuitry and/or software.

The data exchange engine 206 may be configured to enable transfer of data from the database 122 to various engines of the processing circuitry 120. The data exchange engine 206 may be further configured to enable the transfer of data and/or instructions from the user device 102 and/or the nodes 106 to the server 104. Specifically, the data exchange engine 206 may facilitate the processing circuitry 120 to receive the first and second queries from the user device 102.

The registration engine 208 may be configured to enable the user to register into the system 100 by providing registration data through a registration menu (not shown) of the cloud management console 116 that may be displayed by way of the user device 102.

The authentication engine 210 may be configured to fetch the registration data of the user. Specifically, the data exchange engine 206 may facilitate the authentication engine 210 to fetch the registration data of the user and authenticate the registration data of the user. The authentication engine 210, upon successful authentication of the registration data of the user, may be configured to enable the user to log-in or sign-up to the system 100.

In some aspects of the present disclosure, the authentication engine 210 may enable the user to set the password protection for logging-in to the system 100. In such a scenario, the authentication engine 210 may be configured to verify a password entered by the user for logging-in to the system 100 by comparing the password entered by the user with the set password protection. In some aspects of the present disclosure, when the password entered by the user is verified by the authentication engine 210, the authentication engine 210 may enable the user to log-in to the system 100. In some other aspects of the present disclosure, when the password entered by the user is not verified by the authentication engine 210, the authentication engine 210 may facilitate to generate a signal for the notification engine 216 to generate a login failure notification for the user.

The data processing engine 212 may be configured to receive the set of inputs from the user device 102. Specifically, the data exchange engine 206 may facilitate the data processing engine 212 to receive the first and second queries from the user device 102. The data processing engine 212 may be configured to process the first and second queries. Specifically, the data processing engine 212 may be configured to process (i) the one or more services that may be required by the user and (ii) one or more constraints that may be associated with the one or more services.

The pattern generation engine 214 may be configured to generate the pattern of the nodes 106. Specifically, the pattern generation engine 214 may be configured to generate the pattern of the nodes 106 in response to the first and second queries that may be provided by the user through the user device 102. For example, the pattern generation engine 214 may be configured to generate the pattern of the nodes 106 based on parameters such as, compliances, geographical location, available resources, capacity, latency, response time, and the like. In some preferred aspects of the present disclosure, the pattern generation engine 214 may be configured to generate the pattern of the nodes 106 such that the pattern of the nodes 106 is best suited in accordance with the one or more protocols and the one or more constraints. In other words, the pattern of the nodes 106 that may be generated by the pattern generation engine 214 may be best suited for exact technical and legal specifications that may correspond to the first and second queries provided by the user. In some aspects of the present disclosure, the pattern generation engine 214 may be further configured to detect changes in the first and second queries. Specifically, the pattern generation engine 214 may be configured to detect changes in the one or more services and the one or more constraints that may be associated with the one or more services. The pattern generation engine 214 may be further configured to change the pattern of the nodes 106 in response to changes in the one or more services and the one or more constraints. Specifically, the pattern generation engine 214 may be configured to change the pattern of the nodes 106 that may be best suited for new or altered technical and legal specifications.

The notification engine 216 may be configured to facilitate generation of one or more notifications corresponding to the system 100. The one or more notifications may be presented to the user by way of the user device 102. It will be apparent to a person skilled in the art that the aspects of the present disclosure are intended to include and/or otherwise cover any type of notification generated by the system 100 and/or presented to the user by the system 100, without deviating from the scope of the present disclosure.

The database 122 may be configured to store data corresponding to the system 100. The database 122 may be segregated into one or more repositories that may be configured to store a specific type of data. The database 122 may include an instructions repository 218, a user data repository 220, a pattern repository 222, and a protocol repository 224.

The instructions repository 218 may be configured to store instructions data corresponding to the server 104. The instructions data may include data and metadata of one or more instructions corresponding to the various entities of the server 104 such as the processing circuitry 120, the network interface 200, and the I/O interface 202. It will be apparent to a person skilled in the art that the aspects of the present disclosure are intended to include and/or cover any type of instructions data of the server 104, and thus must not be considered as a limitation of the present disclosure.

The user data repository 220 may be configured to store user data of the system 100. The user data may include data and metadata of the data of authenticated users that may be registered on the system 100. The user data repository 220 may further be configured to store partial data and/or partial metadata of the user data corresponding to the users that may fail to register and/or authenticate on the system 100.

Furthermore, the user data repository 220 may be configured to store the set of inputs received from the user by way of the user device 102. It will be apparent to a person skilled in the art that the aspects of the present disclosure are intended to include and/or otherwise cover any type of the user data and/or metadata of the user data of the system 100, and thus must not be considered as a limitation of the present disclosure.

The pattern repository 222 may be configured to store the pattern that may be generated by the processing circuitry 120. Specifically, the pattern repository 222 may be configured to store the pattern that may be generated by the pattern generation engine 214. The pattern repository 222 may be further configured to store altered pattern that may be generated by the processing circuitry 120 in response to the changes in the one or more services and the one or more constraints. Specifically, the pattern repository 222 may be configured to store the altered pattern that may be generated by the pattern generation engine 214 in response to the changes in the one or more services and the one or more constraints.

The protocol repository 224 may be configured to store the one or more protocols that may execute the one or more constraints. The second nodes 126 may be configured to retrieve the one or more protocols from the protocol repository 224. Specifically, the second nodes 126 may be configured to retrieve the one or more protocols from the protocol repository 224 to execute the one or more constraints that may be associated with the one or more services.

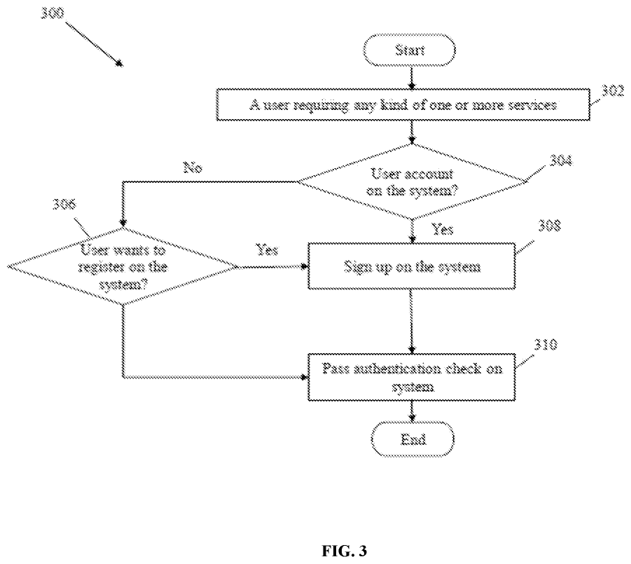

FIG. 3 illustrates a flow diagram of method 300 that facilitates a user to join the system 100, in accordance with an aspect of the present disclosure. In some aspects of the present disclosure, the system 100 may facilitate the user to solicit a cloud-based service either from a dedicated provider selling several vendors for a commission, or through signing up on the system 100.

At step 302, the system 100 may enable an access to a user requiring the one or more services. Specifically, the system 100 may enable the access to the user through the user device 102. The user device 102 may facilitate the user to provide the first query to the system 100 such that the first query corresponds to the one or more services that may be required by the user.

At step 304, the system 100 may determine if the user has an account with the system 100. If the user does not have an account, at step 306, the system 100 may query the user whether the user wants to be registered with the system 100 or not.

At step 308, if the user wants to register with the system 100, the system 100 facilitates the user to create an account and sign up with the system 100. On the other hand, if the user already has an account, the system 100 may facilitate the user to directly sign up with the system 100.

At step 310, if the user does not have an account and further does not want to register on the system 100, the system 100 may pass an authentication check on the system 100 to authenticate the user. The system 100 may further pass the authentication check for signed up users. Further, at step 310, the system 100 may facilitate the user to solicit a cloud-based service.

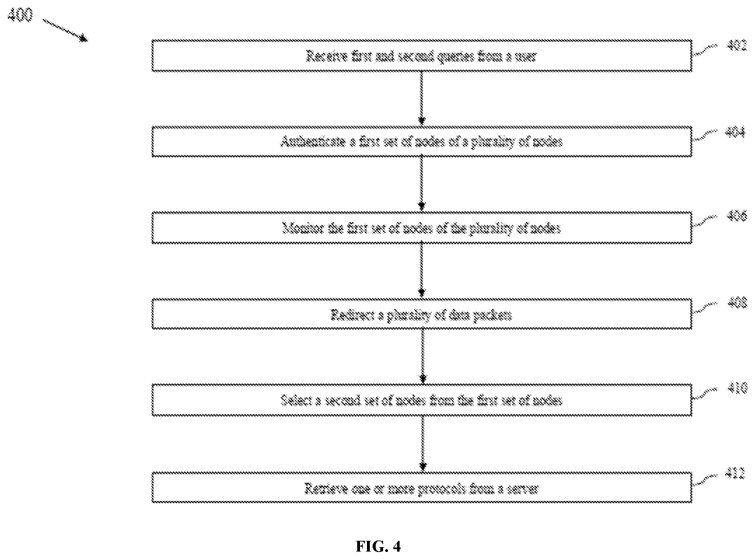

FIG. 4 illustrates a flow diagram of method 400 for cloud management and task allocation to the nodes 106 in a blockchain network, in accordance with an aspect of the present disclosure. The method 400 may include following steps:—

At step 402, the system 100 may receive the first and second queries from the user. Specifically, the system 100, by way of the user device 102, may be configured to receive the first and second queries from the user. The first query may correspond to one or more services that may be required by the user. For example, the one or more services may include, but are not limited to, storage-based services, computational resources, network services, management and orchestration services. The storage-based services may facilitate the user to choose to use an external cloud-based hard drive to save space. The computational resources may facilitate the user to choose to utilize powerful nodes to speed up calculations and efficiency without the burden of having to invest in a supercomputer. The network services may facilitate the user to only pay for a dedicated internet protocol (IP address) to host a website and for other purposes. The management and orchestration services may facilitate the user to utilize dedicated software manufactured by the system 100 that may facilitate management of several hundreds of virtual machines at a large scale. The second query may correspond to one or more constraints that may be associated with the one or more services. The one or more constraints may include, but not limited to, (i) organization-specific constraints that may be required to be met and (ii) legal compliances that may be required to be met.

At step 404, the system 100 may authenticate the first nodes 124. Specifically, the system 100, by way of the nodes 106, may be configured to authenticate the first nodes 124.

At step 406, the system 100 may monitor the first nodes 124. Specifically, the system 100, by way of the nodes 106, may be configured to monitor the first nodes 124 to determine presence of the at least one unhealthy node in the first nodes 124.

At step 408, the system 100 may redirect the plurality of data packets. Specifically, the system 100, by way of the nodes 106, may be configured to redirect the plurality of data packets that may be associated with the at least one unhealthy node. The nodes 106 may be configured to redirect the plurality of data packets to a node that may be near to the at least one unhealthy node.

At step 410, the system 100 may select the second nodes 126 from the first nodes 124. Specifically, the system 100, by way of the nodes 106, may be configured to select the second nodes 126 from the first nodes 124 based on one or more constraints that may be associated with the one or more services.

At step 412, the system 100 may retrieve the one or more protocols from the server 104. Specifically, the system 100, by way of the one or more VM's 128 of the second nodes 126, may be configured to retrieve the one or more protocols from the database 122 of the server 104.

Thus, the system 100 may advantageously enable the user to fine tune the nodes 106 based on the one or more constraints. Specifically, the system 100 may advantageously enable the user to fine tune the nodes 106 based on the organization-specific constraints and legal compliances. The system 100 may advantageously identify the at least one unhealthy node in the nodes 106. The system 100 may advantageously shift operational activities to the node with lower latency.

The foregoing discussion of the present disclosure has been presented for purposes of illustration and description. It is not intended to limit the present disclosure to the form or forms disclosed herein. In the foregoing Detailed Description, for example, various features of the present disclosure are grouped together in one or more aspects, configurations, or aspects for the purpose of streamlining the disclosure. The features of the aspects, configurations, or aspects may be combined in alternate aspects, configurations, or aspects other than those discussed above. This method of disclosure is not to be interpreted as reflecting an intention, the present disclosure requires more features than are expressly recited in each claim. Rather, as the following claims reflect, inventive aspects lie in less than all features of a single foregoing disclosed aspect, configuration, or aspect. Thus, the following claims are hereby incorporated into this Detailed Description, with each claim standing on its own as a separate aspect of the present disclosure.

Moreover, though the description of the present disclosure has included description of one or more aspects, configurations, or aspects and certain variations and modifications, other variations, combinations, and modifications are within the scope of the present disclosure, e.g., as may be within the skill and knowledge of those in the art, after understanding the present disclosure. It is intended to obtain rights which include alternative aspects, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

We claim:

1. A system (100) comprising:
a plurality of nodes (106a-106n) configured to monitor a first set of nodes (124a-124e) to determine presence of at least one unhealthy node in the first set of nodes (124a-124e) such that the plurality of nodes (106a-106n) redirect a plurality of data packets associated with the at least one unhealthy node to a node that is near to the at least one unhealthy node,
wherein the plurality of nodes (106a-106n) further configured to select a second set of nodes (126a-126e) from the first set of nodes (124a-124e) based on one or more constraints associated with one or more services such that the second set of nodes (126a-126e) retrieves one or more protocols to execute the one or more constraints.

2. The system (100) as claimed in claim 1, wherein the plurality of nodes (106a-106n) further configured to authenticate the first set of nodes (124a-124e) prior to monitor the first set of nodes (124a-124e).

3. The system (100) as claimed in claim 1, further comprising a server (104) that is communicatively coupled to the plurality of nodes (106a-106n) and configured to store the one or more protocols that facilitate to execute the one or more constraints.

4. The system (100) as claimed in claim 3, wherein each node of the plurality of nodes (106a-106n) comprising one or more virtual machines (128a-128c) such that the one or more virtual machines (128a-128c) of the second set of nodes (126a-126e) facilitate to retrieve the one or more protocols from the server (104).

5. The system (100) as claimed in claim 4, wherein the one or more virtual machines (128a-128c) of the first set of nodes (124a-124e) facilitates to redirect the plurality of data packets of the at least one unhealthy node to a node that is near to the at least one unhealthy node.

6. The system (100) as claimed in claim 1, further comprising a user device (102) that is communicatively coupled to the plurality of nodes (106a-106n) and configured to receive first and second queries from a user.

7. The system (100) as claimed in claim 6, wherein the first query corresponds to the one or more services that are required by the user and the second query corresponds to the one or more constraints that are associated with the one or more services.

8. A method (400) for cloud management and task allocation, the method (400) comprising:
authenticating (404), by way of a plurality of nodes (106a-106n), a first set of nodes (124a-124e) of the plurality of nodes (106a-106n);
monitoring (406), by way of the plurality of nodes (106a-106n), the first set of nodes (124a-124e) to determine presence of at least one unhealthy node in the first set of nodes (124a-124e);
redirecting (408), by way of the plurality of nodes (106a-106n), a plurality of data packets associated with the at least one unhealthy node to a node that is near to the at least one unhealthy node; and
selecting (410), by way of the plurality of nodes (106a-106n), a second set of nodes (126a-126e) from the first set of nodes (124a-124e) based on one or more constraints associated with one or more services.

9. The method (400) as claimed in claim 6, further comprising, upon selecting the second set of nodes (126a-126e), retrieving (412), by way of one or more virtual machines (128a-128c) of the second set of nodes (126a-126e), the one or more protocols from the server (104).

10. The method (400) as claimed in claim 6, wherein prior to authenticating, the method (400) further comprising receiving (402), by way of a user device (102), first and second queries from a user such that the first query corresponds to the one or more services that are required by the user and the second query corresponds to the one or more constraints that are associated with the one or more services.
